(19) United States
(12) Patent Application Publication
(10) Pub. No.: US 2008/0003051 A1
(43) Pub. Date: Jan. 3, 2008

(54) Pen with rotatable cap

(75) Inventor: Wei Chang, Taipei (TW)

Correspondence Address: BIRCH STEWART KOLASCH & BIRCH, PO BOX 747, FALLS CHURCH, VA, 22040-0747, US

(73) Assignee: FLONTO CORP.

(21) Appl. No.: 11/476,150

(22) Filed: Jun. 28, 2006

(51) Int. Cl. B43K 5/00; B43K 23/12

(52) U.S. Cl. 401/202; 401/243

(57) ABSTRACT

A pen with a rotatable cap is described. The pen comprises a pen barrel, a writing tip and a cap. The pen barrel includes a front end and a rear end, wherein at least one rotation axle protrudes and is set on an outer surface of the pen barrel, and the rotation axle comprises a pillar and a flange connected on an outer end of the pillar. The writing tip is located on the front end of the pen barrel. The cap comprises at least one slide track extending downwards from one side of the cap, and the cap may be put on the front end or the rear end of the pen barrel, wherein a slide is set in the slide track, the slide includes a slide area and a rotation area in contact with each other, and the rotation area is at a terminal point of the slide, wherein the pillar of the rotation axle of the pen barrel is put and can be slid in the slide, and the pillar is rotatable only in the rotation area of the slide.

### FIELD OF THE INVENTION

The present invention relates to a novel design for a pen, and more particularly, to a pen with a rotatable cap, which can prevent the cap from being lost.

### BACKGROUND OF THE INVENTION

In addition to the main elements of a pen (pen barrel and refill), pens usually come with a cap to protect the refill and to prevent the ink on the writing tip from drying. FIG. 1 is a schematic diagram showing a conventional pen structure. A pen 100 is usually composed of three elements, including a pen barrel 102, a refill 106 and a cap 104. In the pen 100, the pen barrel 102 and the cap 104 are usually two independent elements, and the refill 106 is deposed within the pen barrel 102. A writing tip 108 of the refill 106 protrudes out of the front end of the pen barrel 102.

When the pen 100 is not being used, the cap 104 is usually put on the front end of the pen barrel 102 to protect the writing tip 108 from being damaged. On the other hand, when the pen 100 is being used, the cap 104 may be put on the rear end of the pen barrel 102 or is put aside haphazardly according to the habit of the user. Therefore, the cap 104 may fall or may be lost, and cannot protect the writing tip 108 or prevent the ink of the writing tip 108 and/or the whole refill 106 from drying. Furthermore, the exposed writing tip 108 may further contaminate other objects put aside or injure the user.

### SUMMARY OF THE INVENTION

Therefore, one objective of the present invention is to provide a pen with a rotatable cap. The rotateable cap can be moved and rotated to the rear of the pen barrel along a slide track and a rotation axle of the pen barrel. Hence, the pen cap will never have to leave the pen barrel and will therefore be prevented from being lost.

Another objective of the present invention is to provide a pen with a rotatable cap, in which a barrel of the pen includes at least one rectangular rotation axle, so that the cap can be moved along a predetermined path and can be prevented from oscillating during the movement of the cap, thereby preventing the writing tip from being damaged by the oscillation of the cap.

According to the aforementioned objectives, the present invention provides a pen with a rotatable cap, comprising a pen barrel, a writing tip and a cap. The pen barrel includes a front end and a rear end, wherein at least one rotation axle protrudes and is set on an outer surface of the pen barrel, and the rotation axle comprises a pillar and a flange connected on an outer end of the pillar. The writing tip is located on the front end of the pen barrel. The cap comprises at least one slide track extending downwards from one side of the cap, and the cap may be put on the front end or the rear end of the pen barrel, wherein a slide is set in the slide track, the slide includes a slide area and a rotation area are in contact with each other, and the rotation area is at a terminal point of the slide, wherein the pillar of the rotation axle of the pen barrel is put in the slide and may be slid in the slide, and the pillar is rotatable only in the rotation area of the slide.

According to a preferred embodiment of the present invention, the pen barrel includes two rotation axles respectively protruding and set on two opposite outer surfaces of the pen barrel, and the cap correspondingly set with two slide tracks, so as to make the sliding of the cap steadier.

With the rotation axle of the pen barrel and the slide track of the cap, the path of the cap can be confined within a limited distance from the pen barrel without departing from the pen barrel and damaging the writing tip, and can thereby prevent the cap from being lost.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 is a schematic diagram showing a conventional pen structure;

FIG. 2A illustrates a three-dimensional diagram of a pen with a rotatable cap in accordance with a preferred embodiment of the present invention;

FIG. 2B is a lateral view of a pen with a rotatable cap in accordance with a preferred embodiment of the present invention;

FIG. 2C is a front view of a pen with a rotatable cap in accordance with a preferred embodiment of the present invention;

FIG. 2D is a top view of a pen with a rotatable cap in accordance with a preferred embodiment of the present invention;

FIG. 2E is a schematic diagram showing a pulling action of a cap of a pen with a rotatable cap in accordance with a preferred embodiment of the present invention;

FIG. 2F is a schematic diagram showing a pen barrel of a pen with a rotatable cap in accordance with a preferred embodiment of the present invention; and

FIGS. 3A through 3E are schematic flow diagrams showing the action process of a cap of a pen with a rotatable cap in accordance with a preferred embodiment of the present invention.

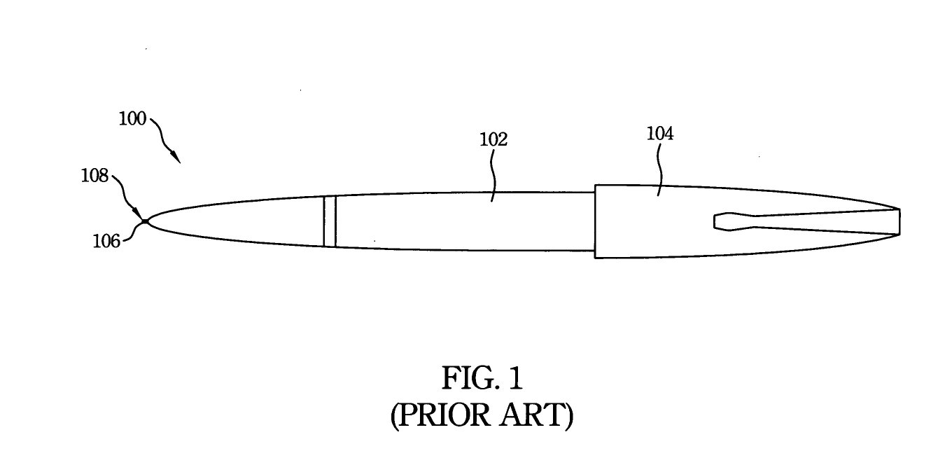

### DETAILED DESCRIPTION OF THE PREFERRED EMBODIMENT

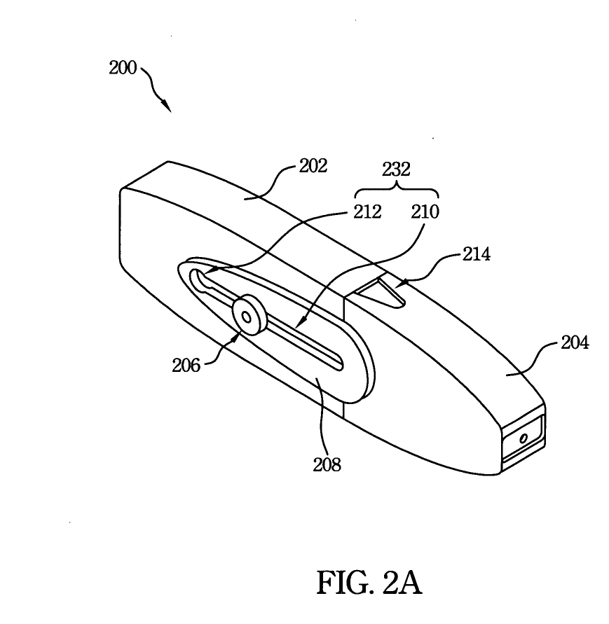

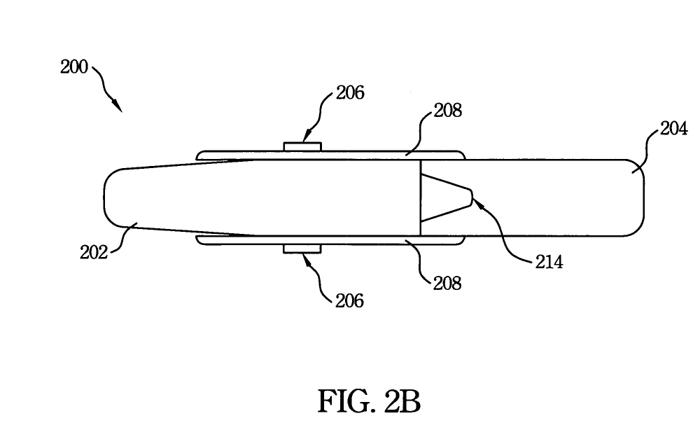

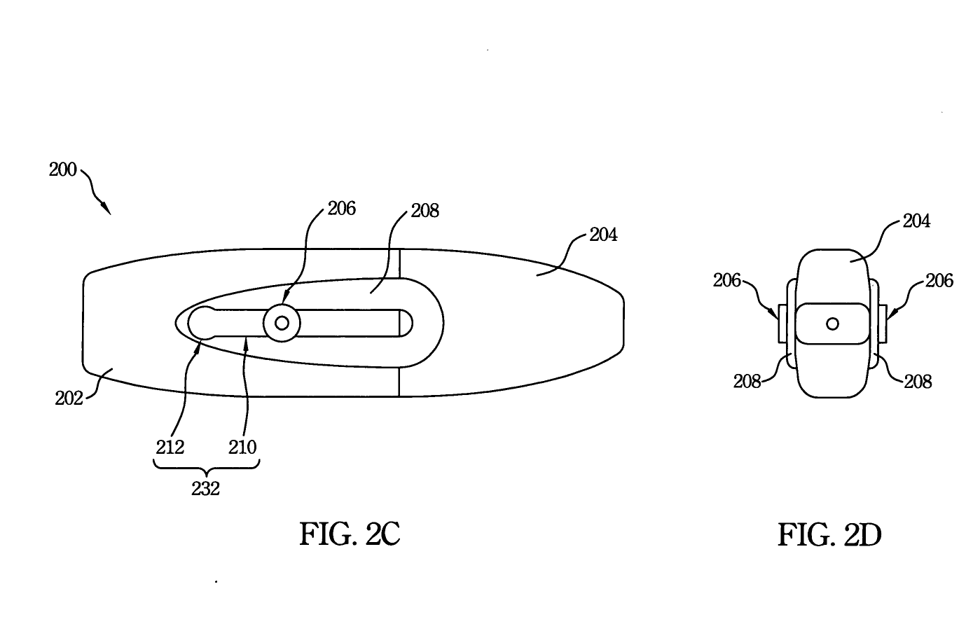

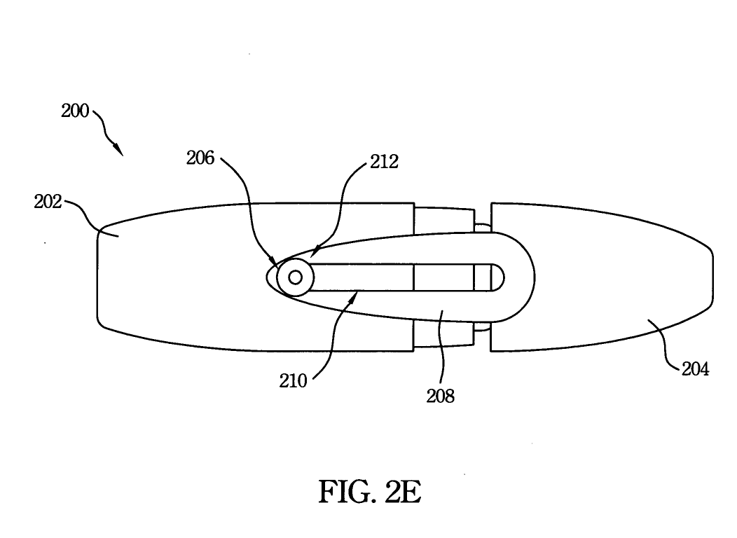

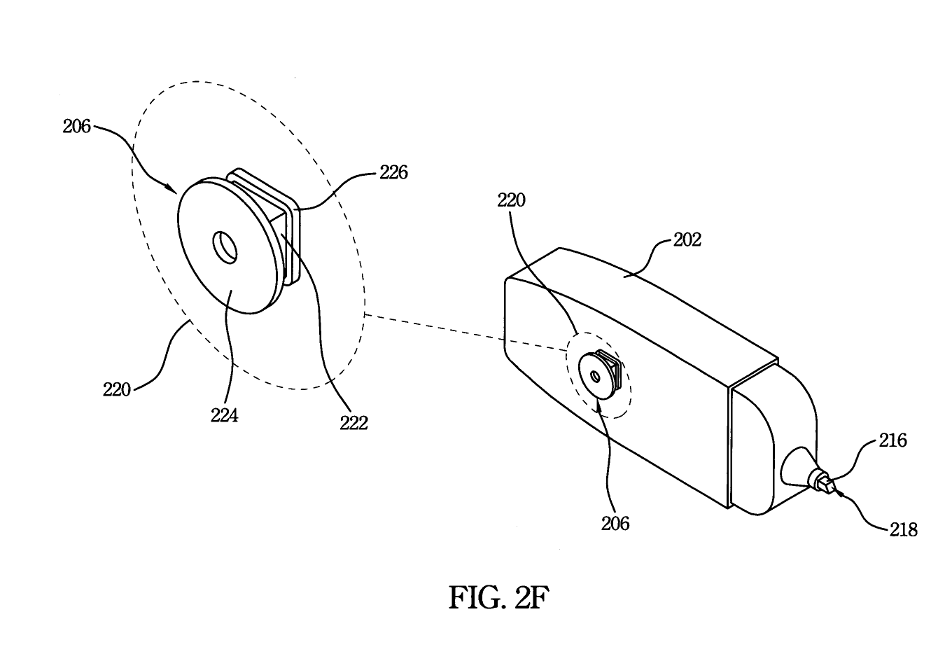

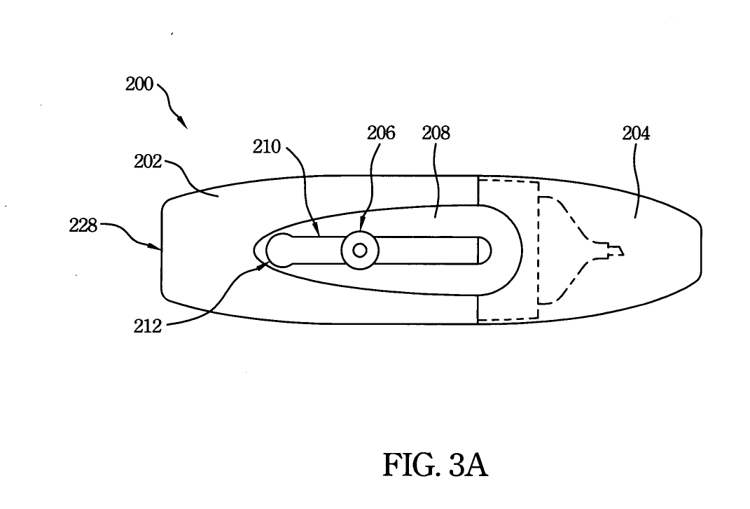

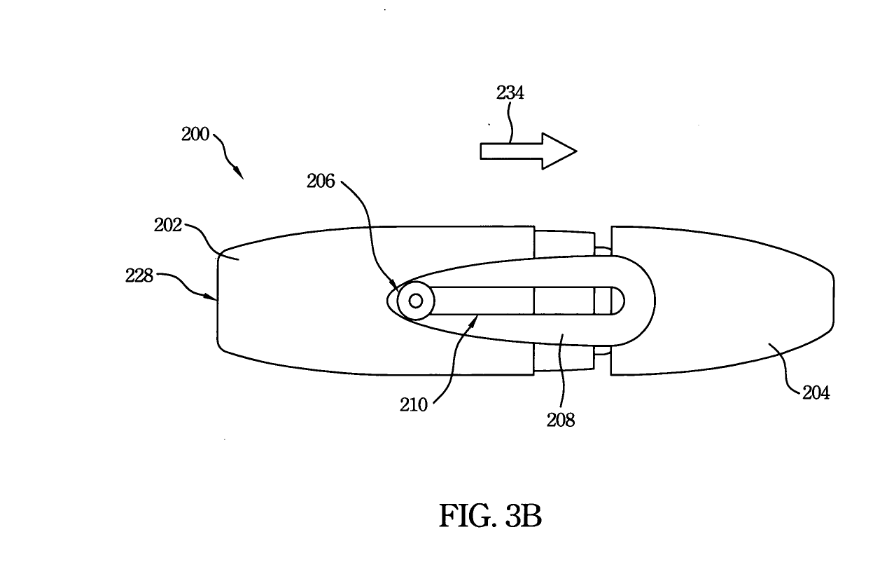

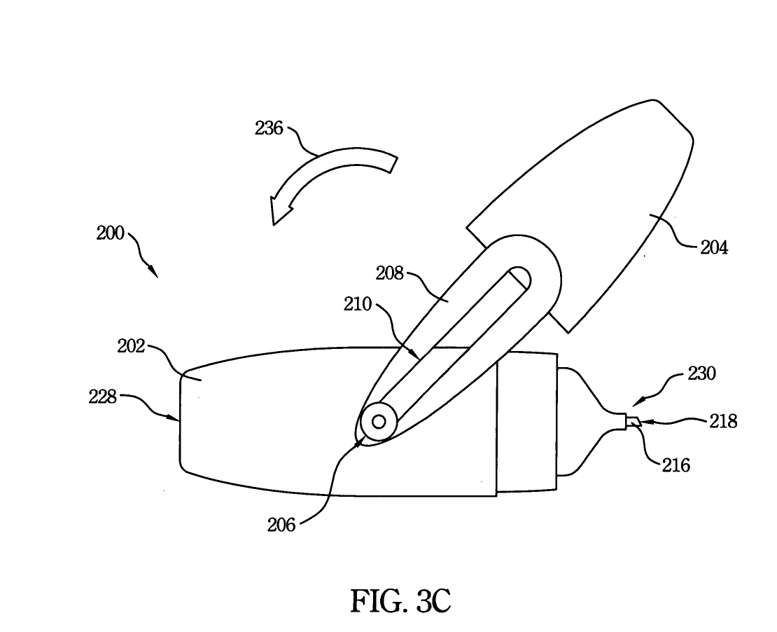

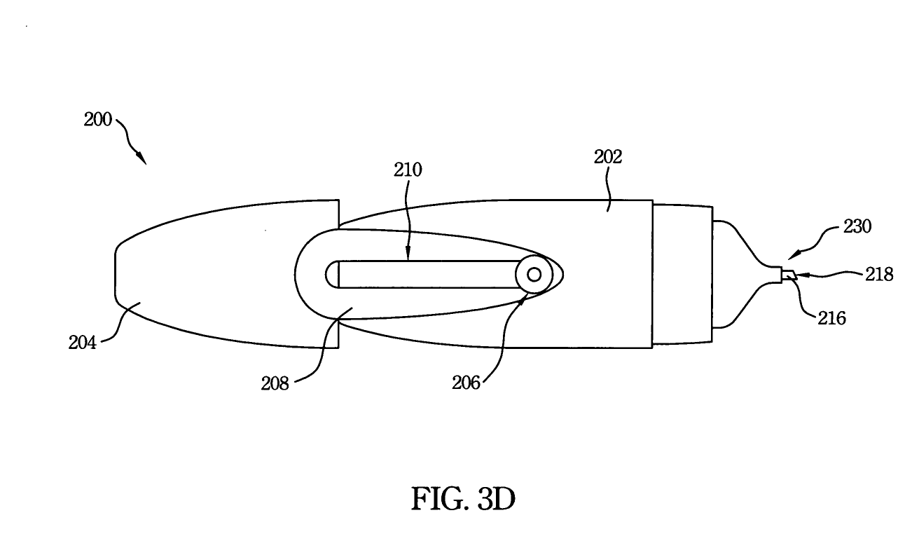

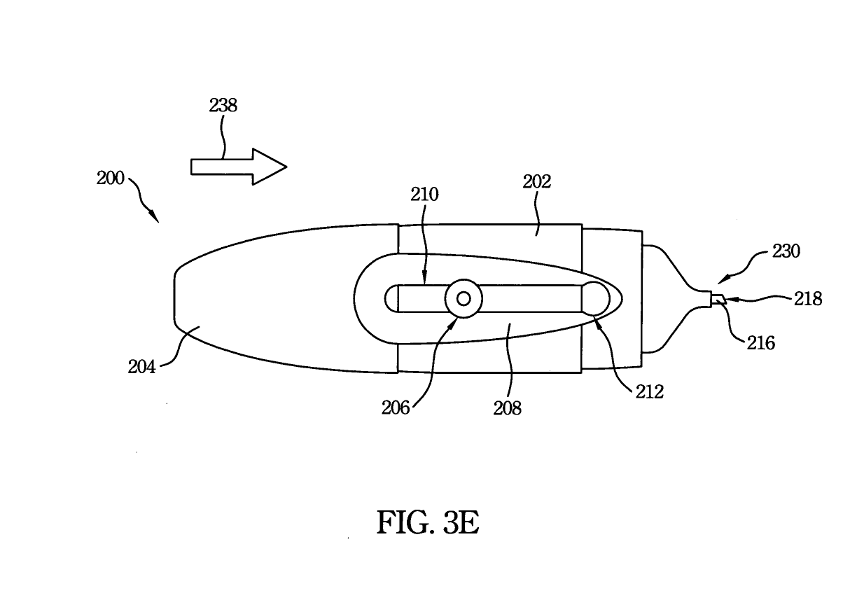

The present invention discloses a pen with a rotatable cap, which can prevent the cap from being lost. In order to make the illustration of the present invention more explicit, the following description is stated with reference to FIGS. 2A through 3E.

FIG. 2A illustrates a three-dimensional diagram of a pen with a rotatable cap in accordance with a preferred embodiment of the present invention. A pen 200 mainly comprises a pen barrel 202 and a cap 204, wherein the cap 204 can be put on a front end 230 or a rear end 228 (as shown in FIG. 3C) of the pen barrel 202, as shown in FIGS. 2A, 3A and 3E. Typically, the pen 200 includes a refill 216, wherein the refill 216 is deposed within the pen barrel 202, and a writing tip 218 at the front end of the refill 216 protrudes out the front end 230 of the pen barrel 202, such as shown in FIGS. 3C through 3E. In some examples, some pens do not include refill elements, and only include a writing tip protruding out the front end of the pen barrel.

In a preferred embodiment of the present invention, the cap 204 comprises two slide tracks 208 extending downwards from two opposite sides of the cap 204, such as FIGS. 2B and 2D. Each slide track 208 has a slide 232 set therein, wherein the slide 232 includes a slide area 210 and a rotation area 212 in contact with each other, and the rotation area 210 is located at the terminal point of the slide 232, as shown in FIGS. 2A and 2C. In the present embodiment, the rotation area 212 is a circular hole, and the diameter of the rotation area 212 is larger than the width of the slide area 210. In the present embodiment, the cap 204 may further comprise two slots 214 set at two. opposite side edges in the rotation direction of the cap 204, so as to make the writing tip 218 smoothly pass through the cap 204 through the slots 214 while rotating the cap 204, such as shown in FIGS. 2A and 2E. In the other embodiment of the present invention, only one slot 214 may be set at one side edge of the cap 204 in the rotation direction of the cap 204.

The pen barrel 202 comprises at least two rotation axles 206 respectively protruding on two outer surfaces of the pen barrel 202, wherein the two outer surfaces are opposite to each other, such as shown in FIGS. 2B and 2D. Each rotation axle 206 mainly comprises a pillar 222 and a flange 224 set on the outer end of the pillar 222, such as illustrated in an enlarged portion 220 in FIG. 2F. The pillars 222 of the rotation axles 206 are respectively set in the slides 232 and can slide in the slides 232. In the present invention, the pillar 222 is preferably a non-circular pillar structure, such as a rectangular pillar structure, a polygonal pillar structure or an elliptical pillar structure. The width of each pillar 222 is slightly smaller than the width of the slide area 210, so that the rotation of the pillars 222 in the slide areas 210 is confined, and the pillars 222 cannot oscillate arbitrarily in the slide areas 210. Accordingly, the pillars 222 can be smoothly moved in the slide areas 210 of the slides 232, and the relative motion between the slide tracks 208 of the cap 204 and the pen barrel 202 can be kept parallel when the cap 204 is pulled away by an user, so as to prevent the cap 204 from oscillating in the process of pulling, thereby preventing the writing tip 218 from being damaged by the cap 204. In the present invention, these pillars 222 may have different shapes or the same shape. Each of the rotation axles 206 may further comprise an isolation base 226 set between the inner end of the pillar 222 and the outer surface of the pen barrel 202 to separate the slide track 208 of the cap 204 and the outer surface of the pen barrel 202, so as to decrease the contact area of the slide track 208 of the cap 204 and the pen barrel 202, thereby reducing the moving friction of the slide track 208.

FIGS. 3A through 3E are schematic flow diagrams showing the process rotating the cap of a pen with a rotatable cap in accordance with a preferred embodiment of the present invention. When the pen 200 of the present embodiment is in an unused state, the cap 204 usually covers the front end of the pen barrel 202 to protect the writing tip 218 on the front end of the pen barrel 202, such as shown in FIG. 3A. Referring to FIG. 3B, when writing with the pen 200, the cap 204 is pulled off the pen in the direction indicated by an arrow 234 and is parallel to the pen barrel 202 with the assistant of the slide tracks 208 of the cap 204 and the rotation axles 206 of the pen barrel 202, until each pillar 222 of the rotation axle 206 is in the rotation area 212 at the terminal point of the slide 232. Now, the slide tracks 208 can be rotated relative to the pillars 222.

Referring to FIG. 3C, the cap 204 is rotated toward the rear end 228 of the pen barrel 202 in the direction indicated by an arrow 236 using the rotation axles 206 as fulcrums. Referring to FIG. 3D, when the cap 204 is rotated to the back of the rear end 228 of the pen barrel 202, the rotation of the cap 204 is stopped. Then, the cap 204 is pushed over the rear end 228 of the pen barrel 202 in the direction indicated by an arrow 238, such as shown in FIG. 3E. The pen 200 can be used to write.

In the other embodiment of the present invention, at least one rotation axle may be only set on one single outer surface of the pen barrel, and one single slide track is set only on one side of the cap accommodating the outer surface of the pen barrel where the rotation axle is located. With the assistance of the rotation axle on the side surface of the pen barrel and the slide track of the cap, the cap can be smoothly rotated by using the rotation axle of the pen barrel as a fulcrum.

According to the aforementioned description, one advantage of the present invention is that in the pen with a rotatable cap, the cap can be moved and rotated to the front end or the rear end of the pen barrel and can be placed on the pen barrel without leaving the pen barrel by being slid along the slide track of the cap and rotated around the rotation axle of the pen barrel, thereby preventing the cap from being lost, protecting the writing tip, prolonging the life of the pen, and preventing from the ink contamination, the ink from drying or injury to the user resulting from the losing of the cap.

According to the aforementioned description, another advantage of the present invention is that the pen barrel of the pen with a rotatable cap includes a non-circular pillar rotation axle, so that the cap can be smoothly moved along a predetermined path and can be prevented from oscillating during the movement of the cap, thereby preventing the writing tip from being damaged by the oscillation of the cap.

As is understood by a person skilled in the art, the foregoing preferred embodiments of the present invention are illustrations of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A pen with a rotatable cap, comprising:
a pen barrel including a front end and a rear end, wherein at least one rotation axle protrudes and is set on an outer surface of the pen barrel, and the rotation axle comprises a pillar and a flange connected on an outer end of the pillar;
a writing tip on the front end of the pen barrel; and
a cap comprising at least one slide track extending downwards from one side of the cap, and the cap may be put on the front end or the rear end of the pen barrel, wherein a slide is set in the slide track, the slide includes a slide area and a rotation area in contact with each other, and the rotation area is at a terminal point of the slide, wherein the pillar of the rotation axle of the pen barrel is put and can be slid in the slide, and the pillar is rotatable only in the rotation area of the slide.

2. The pen with a rotatable cap according to claim 1, wherein the pillar is a rectangular pillar structure.

3. The pen with a rotatable cap according to claim 1, wherein the pillar is a polygonal pillar structure.

4. The pen with a rotatable cap according to claim 1, wherein the pillar is an elliptical pillar structure.

5. The pen with a rotatable cap according to claim 1, wherein the rotation axle further comprises an isolation base set between an inner end of the pillar and the outer surface of the pen barrel.

6. The pen with a rotatable cap according to claim 1, wherein the cap further comprises a slot set at a side edge in the rotation direction of the cap to make the writing tip smoothly pass through the cap.

7. The pen with a rotatable cap according to claim 1, wherein the cap further comprises two slots set at two opposite side edges in the rotation direction of the cap to make the writing tip smoothly pass through the cap.

8. A pen with a rotatable cap, comprising:
a pen barrel including a front end and a rear end, wherein at least two rotation axles respectively protrude and are set on two opposite outer surfaces of the pen barrel, and each of the rotation axles comprises a pillar and a flange connected on an outer end of the pillar;
a writing tip on the front end of the pen barrel; and
a cap comprising two slide tracks extending downwards from two opposite sides of the cap, and the cap may be put on the front end or the rear end of the pen barrel, wherein a slide is set in each slide track, each slide includes a slide area and a rotation area in contact with each other and the rotation area is at a terminal point of the slide, wherein the pillars of the rotation axles of the pen barrel are correspondingly put and can be slid in the slides, and each pillar is rotatable only in the rotation area of the corresponding slide.

9. The pen with a rotatable cap according to claim 8, wherein each of the pillars is a rectangular pillar structure.

10. The pen with a rotatable cap according to claim 8, wherein each of the pillars is a polygonal pillar structure.

11. The pen with a rotatable cap according to claim 8, wherein each of the pillars is an elliptical pillar structure.

12. The pen with a rotatable cap according to claim 8, wherein each of the rotation axles further comprises an isolation base set between an inner end of the pillar and the outer surface of the pen barrel.

13. The pen with a rotatable cap according to claim 8, wherein the cap further comprises a slot set at a side edge in the rotation direction of the cap to make the writing tip smoothly pass through the cap.

14. The pen with a rotatable cap according to claim 8, wherein the cap further comprises two slots set at two opposite side edges in the rotation direction of the cap to make the writing tip smoothly pass through the cap.

15. The pen with a rotatable cap according to claim 8, wherein the pillars have different shapes.

16. The pen with a rotatable cap according to claim 8, wherein the pillars have the same shape.
